(19) United States
(12) Patent Application Publication
(10) Pub. No.: US 2008/0100052 A1
(43) Pub. Date: May 1, 2008

(54) Ramping Mudflap Assembly

(75) Inventors: David M. Oberholtzer, Beverly Hills, MI (US); David Archer, Orion, MI (US); Michael Pritchett, Waterford, MI (US)

Correspondence Address: LANIER FORD SHAVER & PAYNE P.C., P O BOX 2087, HUNTSVILLE, AL, 35804-2087, US

(73) Assignee: Fontaine Spray Suppression Company, Springfield, TN (US)

(21) Appl. No.: 11/927,149

(22) Filed: Oct. 29, 2007

Related U.S. Application Data
(60) Provisional application No. 60/854,882, filed on Oct. 27, 2006.

(51) Int. Cl. B62D 25/16

(52) U.S. Cl. 280/848

(57) ABSTRACT

A mudflap assembly comprising a bracket for connection to a vehicle and a swiveling support is claimed. A mudflap support bar is connected to an upper end of the swiveling support for supporting a mudflap. The bracket rotatably receives the free lower end of the swiveling support hanger and maintains the mudflap support bar in an initial resting position until the support bar is acted upon by a horizontal force. A spring installed on the free lower end of the swiveling support hanger provides compressive force against the bracket.

### REFERENCE TO RELATED APPLICATIONS

This application claims priority to U.S. patent application Ser. No. 60/854,882, entitled “Ramping Mudflap Assembly,” filed on Oct. 27, 2006, which is fully incorporated herein by reference.

### FIELD OF THE INVENTION

The present invention relates generally to the field of spray suppression in commercial trucking. In particular, the present invention relates to a mudflap assembly.

### BACKGROUND OF THE INVENTION

Mudguards or mudflaps are used primarily behind single or dual rear-wheeled truck and trailer vehicles, particularly heavy duty class 6, 7, and 8. Typically, the mudflap assemblies have the ability to flex in horizontal and vertical directions in order to withstand forces placed upon them during normal operation. Some mudguard mounting structures comprise a single piece of spring-like bar stock bent in a shape for supporting the mudguards and for flexing in all directions.

Other mounting assemblies for mudflaps use a rigid hanger assembly and resiliently bias the hanger assembly to a seat which is attached to a vehicle. In such assemblies, devices are often provided for restraining rotational movement of the hanger assembly with respect to the seat so that the mudflap always remains in its vertical orientation. If the hanger rotates so that the flap moves toward the wheels, the wheels may prematurely wear the mudflap away. If the hanger rotates in an opposite direction, the effectiveness of the mudflap may be diminished.

Mudflap brackets having a horizontal tube with a longitudinal mudflap mounting flange on its underside are known. Such brackets comprise a vehicle frame-mounted plate having bolts or studs of a predetermined, fixed separation, often selected to match existing manufacturer provided apertures in the vehicle frame. A proximate end of the horizontal tube is held against the frame-mounted plate, generally in an abutting relationship, by the bias of an elongate spring residing in the tube, the spring connected at one end to the frame-mounted plate and at the other end to the tube, at a location on the tube distal from the vehicle frame.

The abutting relationship of the horizontal tube and mounting plate to the frame-mounted plate may result in misalignment of the tube, which occurs when the tube is struck or subjected to the forces experienced by the vehicle traveling down the road. The bias of the elongate spring may not overcome the misalignment by itself. Corners or edges between the mounting plate, or tube, and the frame-mounted plate catch or hang up on each other, preventing realignment of the tube. Furthermore, such devices can be expensive to manufacture and replace, and are difficult to install and assemble.

### SUMMARY OF THE INVENTION

The present disclosure provides a ramping mudflap assembly. The mudflap bracket contains a universal bolting pattern for attachment to any vehicle frame, and can be made from any material such as metal, composites, or high-density plastics which are capable of withstanding normal operational forces. An L-shaped mudflap hanger is inserted within the bracket leaving the mudflap projecting outwardly. The mudflap hanger may be made of durable material such as metal, composites, or high-density plastics, capable of withstanding normal operational forces. In one embodiment, the mudflap hanger is held in place by a V-shaped groove formed into the hanger which corresponds to V-shaped ramps on the top surface of the mudflap bracket. A spring is slid over the portion of the hanger projecting through the bracket, and a clip is secured to the bottom of the hanger, holding the spring in place. The spring provides a compressive force between the bracket and the clip.

In one embodiment, the mudflap and hanger are pre-formed together. In another embodiment, the mudflap is secured to the hanger using traditional means such as bolts or fasteners. Furthermore, any device or material capable of providing compressive force can be used in the place of the spring. Finally, instead of a clip, a different means of securing the spring to the hanger, such as a cap on the bottom of the hanger may be used so long as the spring can maintain a compressive force on the bottom of the bracket.

Vertical forces experienced by the mudflap assembly are absorbed by the spring, while horizontal forces cause the hanger to rotate about the bracket wherein the V-shaped coupling between the two components causes the hanger and mudflap to become displaced upward and away from such force. Such displacement further compresses the spring such that when the horizontal force is removed, the hanger returns along the ramp to its resting position where the V-shaped groove of the hanger rests within the V-shaped cradle of the bracket

These and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

The present invention is described with reference to the accompanying drawings. In the drawings, like reference numbers indicate identical or functionally similar elements.

FIG. 1 is an exploded perspective view of an embodiment of mudflap assembly according to the present invention.

FIG. 2 is a perspective view of the mudflap assembly of FIG. 1 in an assembled configuration.

FIG. 3 is a frontal perspective view of the bracket illustrated in FIG. 1.

FIG. 4 is a rear perspective view of the bracket illustrated in FIG. 1.

FIG. 5 is a side view of the bracket illustrated in FIG. 1.

FIG. 6 is a top plan view of the bracket illustrated in FIG. 1.

FIG. 7 is a top partial plan view of the mudflap assembly of FIG. 1 in its initial position installed on a vehicle.

FIG. 8 is a top partial plan view of the mudflap assembly of FIG. 6, illustrated in a position wherein the mudflap is being acted on by a horizontal force.

FIG. 9 is a top partial plan view of the mudflap assembly of FIG. 6, wherein the mudflap assembly has been rotated a full 90 degrees from its initial position.

FIG. 10 is an perspective view of a mudflap assembly according to the present disclosure, wherein the mudflap assembly is in its initial position.

FIG. 11 is an enlarged perspective view of the mudflap assembly illustrated in FIG. 10.

FIG. 12 is an enlarged perspective view of a mudflap assembly of FIG. 10, wherein the mudflap assembly has been acted on by a horizontal force.

FIG. 13 is an enlarged perspective view of a mudflap assembly of FIG. 10, wherein the mudflap assembly has been rotated a full 90 degrees from its initial position.

### DETAILED DESCRIPTION

The various embodiments of the present invention and their advantages are best understood by referring to the drawings. The elements of the drawings are not necessarily to scale, emphasis instead being placed upon clearly illustrating the principles of the invention. Throughout the drawings, like numerals are used for like and corresponding parts of the various drawings.

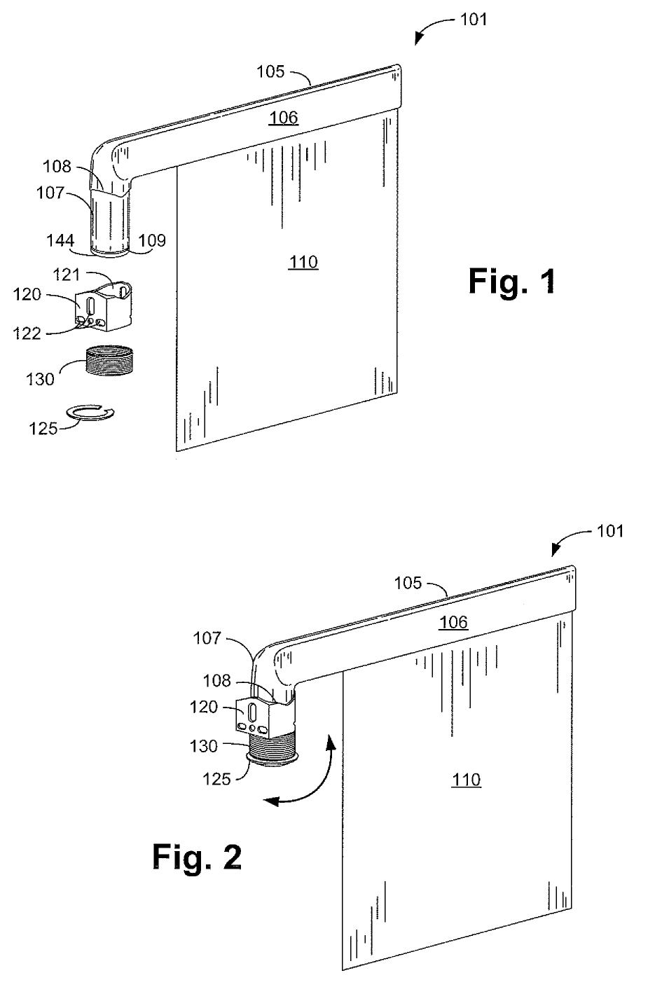

FIG. 1 illustrates an exploded view of one embodiment of mudflap assembly 101, and FIG. 2 illustrates this embodiment in an assembled configuration. Referring to FIGS. 1 and 2, L-shaped hanger 105 comprises mudflap support bar 106 and swiveling support 107. Mudflap support bar 106 is a substantially horizontal bar which provides structural support for resilient mudflap 110. Swiveling support 107 is a substantially vertical and substantially cylindrical support that rotates around its vertical axis to move mudflap 110 out of the way of any obstacles (not illustrated) it encounters. Swiveling support 107 comprises a free bottom end 144 and also comprises one or more V-shaped protrusions 108 which abut bracket 120, as further discussed below.

Support bar 106, swiveling support 107, and mudflap 110 may be provided as a one-piece molded assembly, or may comprise separate components that are joined together by any number of means known in the art. Further, support bar 106 and swiveling support 107 may consist of a one-piece assembly that is connected to a separable mudflap 110. This arrangement may be desirable for ease of changing out worn mudflaps 110.

Bracket 120 rotatably connects the support bar 106, swiveling support 107, and mudflap 110 to a vehicle (not illustrated). Bracket 120 comprises a substantially cylindrical main opening 121 for receiving swiveling support 107. Bracket 120 further comprises fastener holes 122 for receiving fasteners (not illustrated) that connect bracket 120 to the vehicle (the vehicle being described further with reference to FIGS. 6-8). FIG. 2 illustrates swiveling support 107 installed into bracket 120.

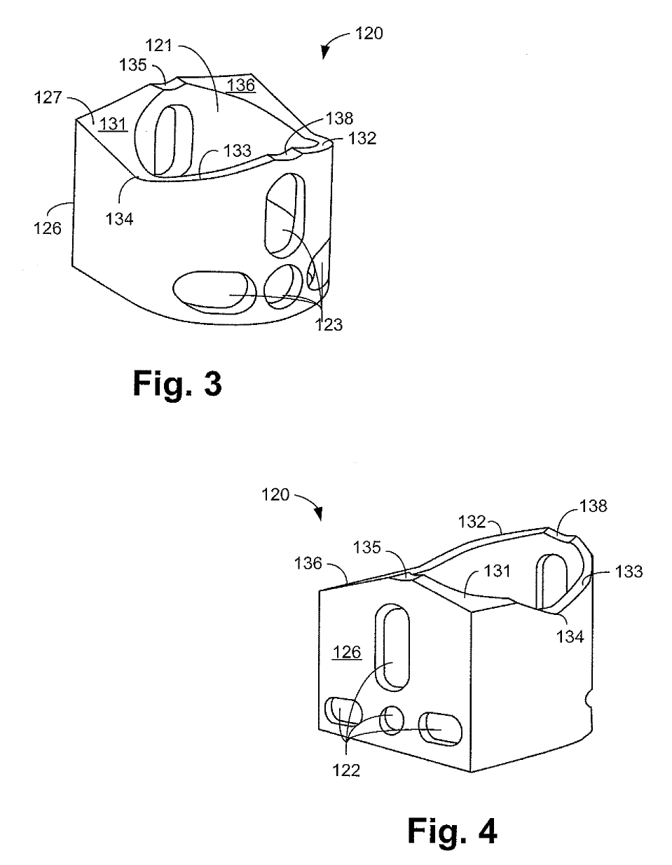

FIGS. 3 and 4 illustrate front and rear perspective views, respectively, of one embodiment of bracket 120. Main opening 121, a substantially vertical and substantially cylindrical channel, receives swiveling support 107 (FIGS. 1-2). Fastener holes 122 in substantially flat rear side 126 receive standard fasteners (not illustrated) for attaching bracket 120 to a vehicle (not illustrated). Fastener holes are illustrated in a universal bolt pattern, but may be provided in any practicable pattern, number, and size. Access holes 123 provide access for tools (not illustrated) to install fasteners into fastener holes 122.

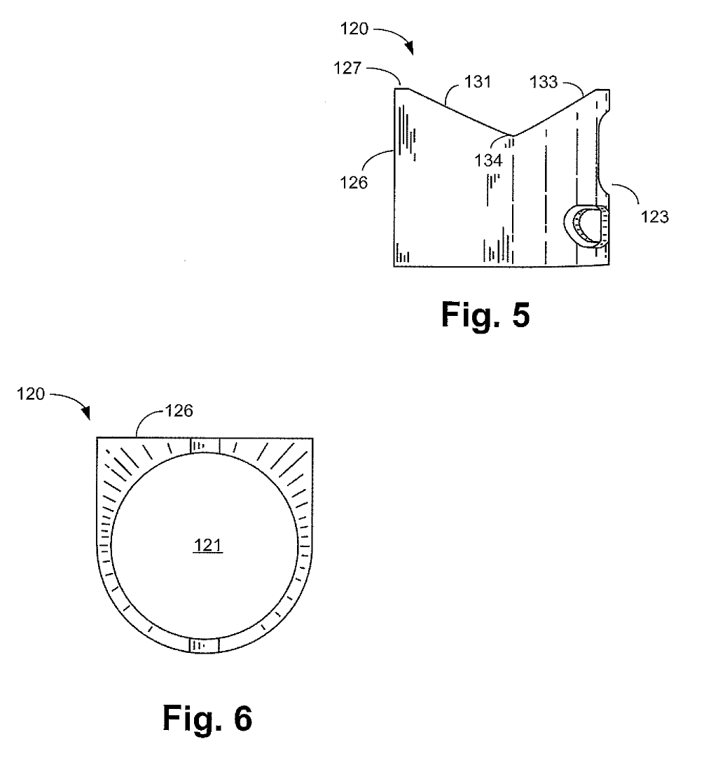

Top surface 127 of bracket 120 comprises ramped or angled features to partially conform to angled protrusions 108 (FIG. 1) on swiveling support 107 (FIG. 1). More specifically, referring to FIGS. 3 and 4, and with further reference to FIG. 5, top surface 127 comprises two mirror-imaged downward-sloping ramps 131 and 136 that slope downwardly from the rear side 126 of bracket 120. Two mirror-imaged upward-sloping ramps 133 and 132 adjacent to downward-sloping ramps 131 and 136, respectively, slope upwardly from the lowermost point 134 of the top surface 127 of bracket 120. As can be seen in the side view of FIG. 5, the ramps 131 and 133 form a “V” shape, or valley, where ramps 131 and 133 meet on one side of bracket 120. Similarly, ramps 132 and 136 form a “V” shape or valley where they meet on the other side of bracket 120.

Referring to FIGS. 3 and 4, forward notch 138 is disposed at the forward top edge of bracket 120 where upward-sloping ramp 133 approaches upward-sloping ramp 132. Rearward notch 135 is disposed at the rearward top edge of bracket 120 at the location where downward-sloping ramp 136 approaches downward-sloping ramp 131.

Spring 130 (FIGS. 1 and 2) is installed onto swiveling support 107 and is retained on support 107 by clip 125. Spring 130 contacts and exerts a force in the +y direction against bracket 120. Spring 130 is illustrated as a traditional spiral-type spring, but may be any appropriate visoelastic compressive material known in the art that would provide adequate force against bracket 120, such as rubber, elastic, and the like. In the illustrated embodiment, clip 125 is a semi-circular clip that engages groove 109 on support 107 to retain spring 130. Other suitable types of clips or retention mechanisms are well known in the art.

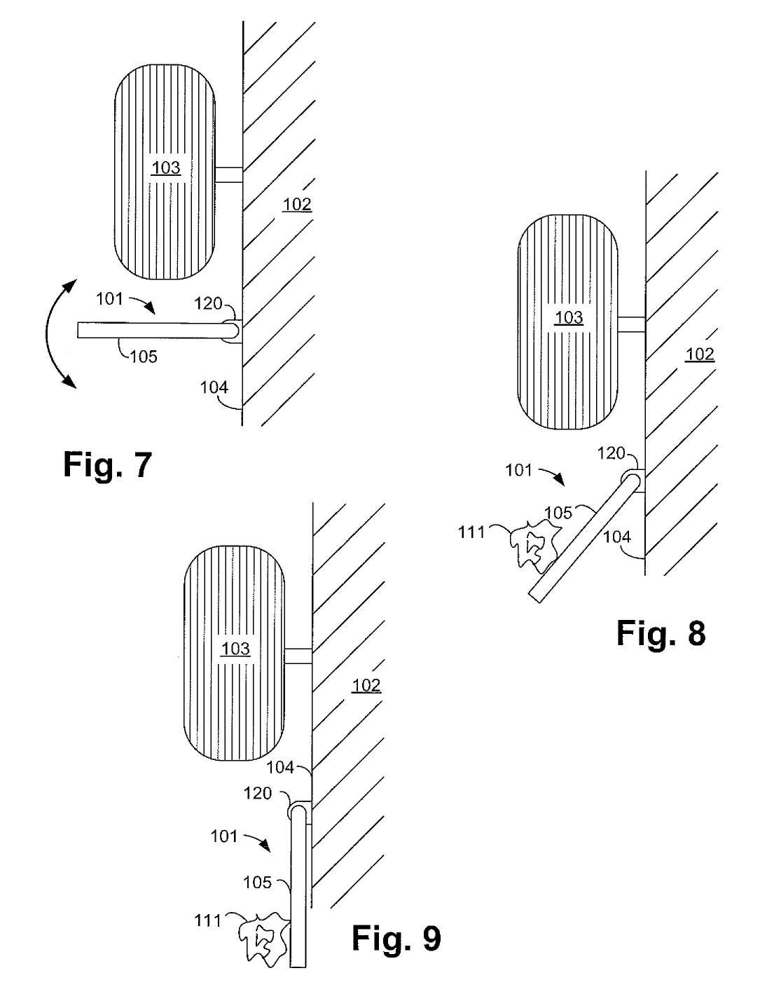

FIGS. 7-9 illustrate the orientation of the mudflap assembly 101 during operation. Specifically, FIG. 7 is a top partial view of a vehicle 102 with a mudflap assembly 101 installed behind a wheel 103, wherein the mudflap assembly 101 is in its initial or “resting” orientation (i.e., when no force has been applied to the mudflap 110 (FIG. 1) or L-shaped hanger 105 sufficient to move L-shaped hanger 105 from its starting position perpendicular to the side 104 of the vehicle 102). As illustrated in FIG. 8, upon contact by an obstacle or object 111, L-shaped hanger 105 may experience sufficient horizontal force to rotate in either a forwards or backwards direction as it swivels within bracket 120. When the force is removed from the hanger 105, the hanger will return to its initial or resting position. FIG. 9 illustrates the L-shaped hanger 105 after it has rotated a full 90 degrees from its initial position.

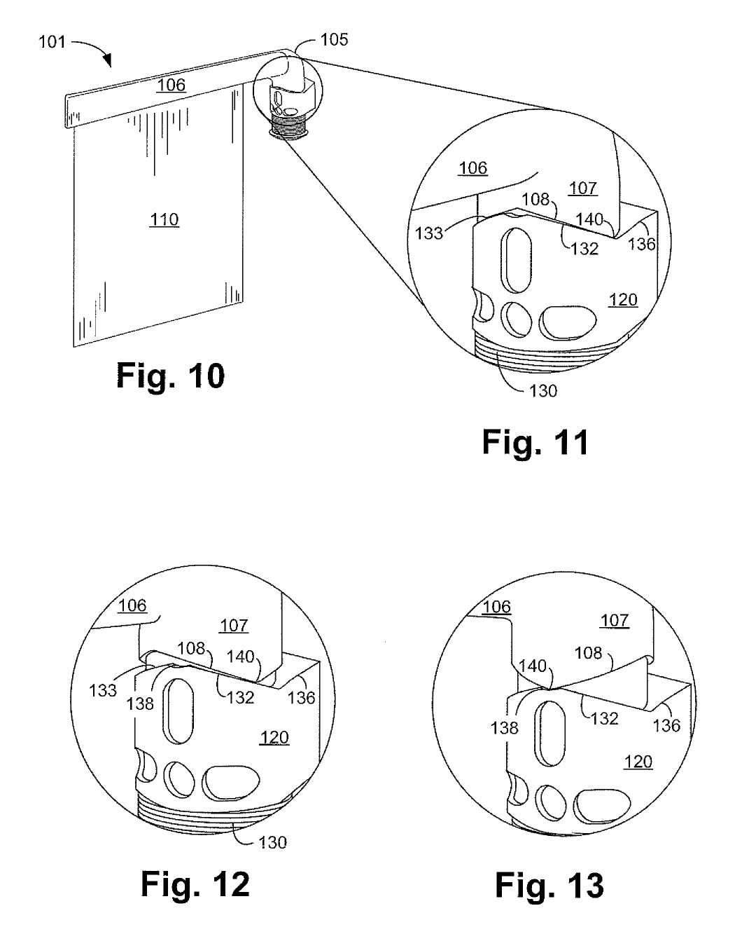

FIGS. 10, 11 and 12 illustrate the interoperation of bracket 120 with vertical support 107 during the rotation of mudflap assembly 101 described in the preceding paragraph. Referring to FIGS. 10 and 11, when the mudflap assembly 101 (FIGS. 1 and 2) is in its resting position, V-shaped protrusions or outcropping 108 (FIG. 1) on swiveling support 107 substantially align with the “V” shaped surfaces created by downward-sloping ramp 136 adjacent to upward-sloping ramp 132 and downward-sloping ramp 131 (FIG. 3) adjacent to upward-sloping ramp 133. The force of spring 130 pressing against bracket 120 causes the protrusions 108 of swiveling support 107 to press tightly against the top surface 127 of bracket 120.

When a horizontal force is applied to L-shaped hanger 105 (e.g., when the hanger 105 encounters an obstacle 111 (FIGS. 8-9)), swiveling support 107 may begin to rotate within bracket 120 in the direction opposite from the force. As swiveling support 107 rotates, lowermost point 140 on V-shaped protrusion 108 presses against upward-sloping ramp 132, as illustrated in FIG. 12. When the horizontal force is removed from hanger 105, lowermost point 140 will “travel” back down ramp 132 and the mudflap assembly 101 will return to its resting position (as illustrated in FIGS. 10 and 11).

Regardless of what direction the swiveling support 107 rotates after the hanger 105 is acted upon by a force, the biasing force caused by ramps 131, 132, 133, or 136 pressed against V-shaped protrusions 108 causes the swiveling support 107 to return to its initial resting position. An exception to this general rule occurs when the horizontal force on hanger 105 is sufficient to rotate swiveling support 107 approximately 90 degrees, which causes lowermost point 140 to travel all the way “up” ramp 132 until it comes to a rest in notch 138, which prevents swiveling support 107 from rotating beyond 90 degrees. Once swiveling support 107 has rotated approximately 90 degrees such that point 140 rests in notch 138, swiveling support 107 will remain in that position until it is manually “reset” to its initial position.

Although protrusions 108 are illustrated as a V-shaped surface that contacts with the ramped surfaces of bracket 120, in other embodiments protrusions 108 may have other shapes and configurations, such as a pin or knob protruding from the swiveling support 107.

The illustrated embodiments of bracket 120 (see FIGS. 3 and 4) include mirror-imaged downward-sloping ramps 131 and 136 and mirror-imaged upward-sloping ramps 133 and 132, and bracket 120 is symmetrical about the axis running through notches 130 and 135. Further, the top surface 127 is illustrated as being symmetrical from the side view, as illustrated in FIG. 5. This configuration allows bracket 120 to be used installed on either the right or left side of a vehicle, and for the mudflap 110 to rotate both frontwards and backwards when installed in either location. Other embodiments of the bracket 120 may be tailored to either the left or right side of the invention, and therefore may not have the mirror-imaged ramps or the above-described symmetry.

This invention may be provided in other specific forms and embodiments without departing from the essential characteristics as described herein. The embodiments described above are to be considered in all aspects as illustrative only and not restrictive in any manner. The following claims rather than the foregoing description indicate the scope of the invention.

As described above and shown in the associated drawings, the present invention comprises a mudflap assembly. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

What is claimed is:

1. A mudflap assembly comprising
a support bar for supporting a mudflap;
a bracket rotatably coupled to the support bar, such that upon impact of the mudflap with an obstacle the support bar rotates thereby radially displacing the mudflap from an initial position, the bracket further comprising a biasing mechanism for radially replacing the mudflap to the initial position.

2. The mudflap assembly of claim 1, wherein the support bar comprises a substantially horizontal bar for coupling to the mudflap and a substantially vertical swiveling support bar.

3. The mudflap assembly of claim 2, wherein the bracket further comprises a ramped surface positioned to contact with at least one protrusion on the substantially vertical support bar in order to maintain the horizontal bar in an initial resting position before a horizontal force acts upon the horizontal bar, and to urge the horizontal bar to return to its initial position after the force is removed from the horizontal bar.

4. The mudflap assembly of claim 2, wherein the swiveling support bar, horizontal support bar, and mudflap are a one-piece unit.

5. The mudflap assembly of claim 3, further comprising a spring for applying a substantially vertical upward force against the bracket.

6. The mudflap assembly of claim 5, wherein the spring comprises a visoelastic material.

7. The mudflap assembly of claim 5, further comprising a clip for retaining the spring and the swiveling support bar onto the bracket.

8. The mudflap assembly of claim 7, wherein the lower end of the swiveling support bar comprises grooves for receiving the clip.

9. The mudflap assembly of claim 3, wherein the at least one protrusion comprises a V-shaped outcropping.

10. The mudflap assembly of claim 3, wherein the bracket further comprises a top surface comprising at least one notch at the upper end of a ramped surface for receiving and retaining the protrusion and therefore preventing the horizontal bar from returning to its initial position after the horizontal bar rotates substantially ninety degrees from its initial position.

11. A mudflap assembly comprising
a substantially vertical swiveling support hanger with a free lower end;
a mudflap support bar connected to an upper end of the swiveling support for supporting a mudflap;
a bracket for connecting to a vehicle and for rotatably receiving the free lower end of the swiveling support hanger;
a spring exerting a spring force on the bracket,
wherein the bracket further comprises a ramped surface comprising at least one downward-sloping ramp adjacent at least one upward-sloping ramp creating at least one valley where the downward-sloping ramp meets the upward-sloping ramp, and
wherein at least one protrusion on the swiveling support hanger is urged by the spring force to maintain an initial position in the valley unless the mudflap support bar is acted upon by a horizontal force sufficient to displace the protrusion from the valley.

12. The mudflap assembly of claim 11, wherein the ramped surface further comprises at least one notch at the top of the upward-sloping ramp for receiving and retaining the protrusion and therefore preventing the mudflap support bar from returning to its initial position after the mudflap support bar rotates substantially ninety degrees from its initial position.

13. A method, comprising the steps of:
supporting a mudflap with a support bar;
upon impact of the mudflap with an obstacle, rotating the support bar thereby radially displacing the mudflap from an initial position; and
radially replacing the mudflap to the initial position via a biasing mechanism.

14. The method of claim 13, wherein the supporting step further comprises the step of supporting the mudflap with a horizontal support bar.

15. The method of claim 13, wherein the replacing step further comprises the steps of positioning a ramped surface of the biasing mechanism to contact at least one protrusion on the support bar in order to maintain the mudflap support bar in an initial resting position before any horizontal force acts upon the mudflap support bar.

16. The method of claim 15, further comprising the step of urging the mudflap support bar to return to its initial position after the support bar has been acted on by a horizontal force.

17. The method of claim 13, further comprising the step of applying a substantially vertical upward force against biasing mechanism.

18. The method of claim 13, further comprising the step of preventing the mudflap support bar from returning to its initial position after the mudflap support bar rotates substantially ninety degrees from its initial position.

19. A mudflap assembly comprising a bracket;
an L-shaped mudflap hanger further comprising a mudflap; and
a ramping means;
wherein the hanger couples to the bracket thus extending the mudflap substantially perpendicularly from the vehicle, and
wherein the ramping means causes the mudflap hanger to travel up and away from forces placed thereon.
